(19) United States
(12) Patent Application Publication
(10) Pub. No.: US 2026/0268134 A1
(43) Pub. Date: Sep. 10, 2026

(54) APPARATUS AND METHOD FOR PROCESS ANALYSIS BASED ON A CNN AUTOENCODER USING CONTROL LOGIC AND ANALOG DATA

(71) Applicant: UDMTEK CO., LTD., Gyeonggi-do (KR)

(72) Inventors: So Hyang Oh, Gyeonggi-do (KR); Nam Ki Kim, Gyeonggi-do (KR); Seung Seok Jeon, Gyeonggi-do (KR); Yeo Reum I, Gyeonggi-do (KR); Gi Nam Wang, Gyeonggi-do (KR)

(73) Assignee: UDMTEK CO., LTD., Gyeonggi-do (KR)

(21) Appl. No.: 19/202,756

(22) Filed: May 8, 2025

(30) Foreign Application Priority Data
Mar. 7, 2025 (KR) 10-2025-0029505

(51) Int. Cl. G06N 3/08; G06N 3/0464; G06V 10/44; G06V 10/82

(52) U.S. Cl. CPC G06N 3/08; G06N 3/0464; G06V 10/44; G06V 10/82

(57) ABSTRACT

The present specification discloses a CNN Autoencoder-based process analysis apparatus and method utilizing control logic and temperature data. The process analysis apparatus according to the present specification trains a model using combined data of equipment operation Gantt charts and temperature variation graphs, enabling it to detect abnormalities by recognizing internal pattern changes in the process without relying on specific data parameters. The process analysis apparatus according to the present specification can provide a novel solution for process improvement by identifying issues that are difficult to detect with conventional data analysis-based anomaly detection models. Furthermore, by interpreting the training dataset in the form of images, the process analysis apparatus can be implemented not only in the manufacturing industry but also in any field where data patterns exist, without requiring complex data preprocessing.

### BACKGROUND

### 1. Field of the Invention

The present invention relates to a process analysis apparatus and method, and more particularly, to a CNN Autoencoder-based process analysis apparatus and method utilizing control logic and analog data.

### 2. Discussion of Related Art

The contents described in this section are merely provided as background information for the embodiments described in the present specification and are not necessarily to be construed as prior art.

The stability and efficiency of a manufacturing process are factors that directly affect not only the quality of the products but also productivity and cost efficiency. Manufacturing companies are making active efforts to improve these aspects in order to secure their competitiveness. Process stability can be achieved when the operation of equipment proceeds as designed, and efficiency can be enhanced through optimization activities once operational stability is ensured. Abnormal equipment operation can act as a cause of process delays, potentially leading to serious consequences such as the shutdown of production lines, which in turn may result in trust issues between consumers and suppliers. Therefore, normal equipment operation in a manufacturing process is an essential condition for process improvement.

To address such demands, the present applicant has previously proposed a method capable of automatically verifying PLC control logic based on a Graph Neural Network (GNN) in Korean Registered Patent Gazette No. 10-2535018. Meanwhile, as there are various types of artificial neural networks, there is also a need for a process analysis method based on a Convolutional Neural Network (CNN).

### SUMMARY OF THE INVENTION

The present specification is directed to providing an apparatus and method capable of efficiently analyzing abnormalities in a process.

The present specification is not limited to the above-mentioned object, and other objects not specifically mentioned will be clearly understood by those skilled in the art from the following description.

According to one aspect of the present embodiment, a process analysis apparatus, comprising: a hardware processor; and a memory connected to the processor and storing at least one computer program configured to perform a process analysis method, wherein the process analysis method comprises: (a) segmenting digital data acquired during a process according to process cycles and converting the segmented digital data into a Gantt chart format; (b) matching analog data acquired during each cycle of the segmented digital data with the segmented digital data and converting the matched analog data into a graph format; (c) converting the Gantt chart and the graph corresponding to each cycle into a single image data; (d) training a model composed of a convolutional neural network using the image data; and (e) inputting an image data, generated through the same procedures as in steps (a) to (c) for a target process to be analyzed, into the trained convolutional neural network model, and outputting a value from the convolutional neural network model related to an abnormality in the process. A process analysis apparatus according to the present specification for solving the above-described problems may include: a hardware processor; and a memory connected to the processor and storing at least one computer program configured to perform a process analysis method.

According to one embodiment of the present specification, wherein the digital data acquired during the process is PLC control logic data.

According to one embodiment of the present specification, wherein the step (a) comprises selecting one reference cycle from among a plurality of cycles, extracting a list of digital data within the reference cycle, and generating a Gantt chart corresponding to each cycle based on the order of the extracted digital data.

Preferably, wherein the step (a) comprises converting the digital data into a Gantt chart format in such a way that even digital data not collected during the process is indicated in terms of its presence.

According to one embodiment of the present specification, wherein the step (b) comprises converting the analog data for each cycle into a graph format by setting the minimum and maximum values of the analog data as the Y-axis range.

According to one embodiment of the present specification, wherein the step (c) comprises converting the Gantt chart and the graph into black-and-white images having the same horizontal length.

According to one embodiment of the present specification, wherein the step (d) comprises extracting a feature matrix such that a value of “1” is assigned to each grid of the image data where the color is white and a value of “0” where the color is black, and inputting the extracted feature matrix into the convolutional neural network.

According to one embodiment of the present specification, wherein the step (d) comprises, in a case where a grid does not clearly distinguish the boundary of the Gantt chart and the graph and contains a mixture of colors, extracting a matrix value based on the ratio of colors within the grid.

The process analysis method according to the present specification may be implemented in the form of a computer program recorded on a computer-readable recording medium, the program being written to perform each step of the method on a computer.

Other specific details of the present invention are included in the detailed description and drawings.

According to one aspect of the present specification, in situations where it is difficult to secure normal data for model training, a self-supervised learning model training environment is established by utilizing the imbalanced nature of process data, and the anomaly classification performance is successfully verified, thereby enhancing applicability in various industrial sites.

According to another aspect of the present specification, by interpreting the process with a focus on internal change patterns instead of numerical values of process data, it is possible to effectively learn normal cycles and classify abnormal cycles even in process environments where trends exist.

According to yet another aspect of the present specification, by combining equipment operation data and sensor measurement data as a basis for detecting process anomalies, it is possible to detect various types of causes and effectively identify process issues such as process delays or omissions in equipment operations, which are difficult to detect through conventional quantitative data analysis.

According to yet another aspect of the present specification, by interpreting process data in the form of images, it is possible to build a model without separate complex processing even in process environments where various types of data are collected.

The effects of the present invention are not limited to those mentioned above, and other effects not specifically mentioned will be clearly understood by those skilled in the art from the following description.

### BRIEF DESCRIPTION OF DRAWINGS

FIG. 1 is a temperature graph of a mold according to a casting process.

FIG. 2 is a schematic flowchart of a process analysis method according to the present specification.

FIG. 3 is a reference diagram for preprocessing of digital data according to the present specification.

FIG. 4 is an exemplary diagram showing a portion of the Gantt chart of digital data and the connection relationship of operations.

FIG. 5 is an example of segmentation of casting process data.

FIG. 6 is a reference diagram of digital data processing for effective training of a neural network model.

FIG. 7 is a reference diagram of analog data processing for smooth training of a neural network model.

FIG. 8 is an example of image data in which digital data and analog data are combined.

FIG. 9 is an exemplary diagram showing the conversion of image data into matrix values.

### DETAILED DESCRIPTION OF EXEMPLARY EMBODIMENTS

The advantages and features of the invention disclosed in the present specification, and methods for achieving them, will become apparent with reference to the embodiments described in detail below in conjunction with the accompanying drawings. However, the present specification is not limited to the embodiments disclosed below, but may be implemented in various different forms. The embodiments are merely provided to ensure completeness of the disclosure and to fully convey the scope of the present specification to those of ordinary skill in the art (hereinafter referred to as “those skilled in the art”), and the scope of rights of the present specification is defined only by the scope of the claims.

The terminology used in the present specification is for the purpose of describing embodiments only and is not intended to limit the scope of rights of the present specification. As used herein, the singular forms also include the plural forms unless the context clearly indicates otherwise. The terms “comprises” and/or “comprising,” as used in the specification, do not exclude the presence or addition of one or more components other than the components mentioned.

Throughout the specification, like reference numerals refer to like elements, and “and/or” includes each and every combination of the mentioned elements. Although terms such as “first,” “second,” etc., may be used to describe various components, it is to be understood that these components are not limited by these terms. These terms are merely used to distinguish one component from another. Therefore, a first component described below may be a second component within the technical scope of the present invention.

Unless otherwise defined, all terms (including technical and scientific terms) used in the present specification shall have the meanings commonly understood by those of ordinary skill in the art to which the present specification pertains. In addition, terms that are generally defined in commonly used dictionaries shall not be interpreted in an idealized or overly formal sense unless explicitly defined otherwise.

The process analysis apparatus according to the present specification may be implemented in various forms. According to one embodiment of the present specification, the process analysis apparatus may include a hardware processor and a memory. The hardware processor may perform computations and execute various control logic. The hardware processor may include a microprocessor, an ASIC (application-specific integrated circuit), other chipsets (ex: CPU, GPU, NPU), logic circuits, registers, communication modems, data processing devices, and the like. The memory is connected to the processor and may store at least one computer program configured to perform the process analysis method according to the present specification. When implemented in software, the computer program may be implemented as a set of program modules and may be executed by the processor.

The memory refers not to media that store data for a brief moment such as registers, caches, or temporary memory, but to media that store data semi-permanently and can be read by a device. Specifically, examples of such storage media include, but are not limited to, ROM, RAM, CD-ROM, magnetic tape, floppy disks, and optical data storage devices. That is, the computer program may be stored on various recording media on various servers accessible by a computer, or on various recording media on a user's computer. In addition, the memory may be distributed across computer systems connected via a network, with computer-readable code stored in a distributed manner.

The computer program may include code encoded in a computer language such as C/C++, C#, JAVA, Python, or machine language, which can be read through the device interface of the computer by the processor (CPU) of the computer in order to execute the methods implemented as a program. Such code may include functional code related to functions such as functions defined to execute the necessary operations of the methods, and may include control code related to execution procedures necessary for the processor of the computer to execute the functions in a predetermined sequence. Additionally, the code may further include memory reference-related code specifying which location (address) in the internal or external memory of the computer should be referenced for additional information or media required for the processor of the computer to execute the functions. Furthermore, if communication with another computer or server located remotely is required for the processor of the computer to execute the functions, the code may further include communication-related code specifying how to communicate with the remote computer or server using the communication module of the computer and what information or media should be transmitted and received during the communication.

Hereinafter, a process analysis apparatus and method according to the present specification will be described with reference to the accompanying drawings. The present specification presents a casting process as an example. The casting process is a process in which molten metal is injected into a mold to produce parts. The casting process includes a heating step, and thus the temperature tends to gradually increase as the process progresses. However, the process analysis apparatus and method according to the present specification are not limited to analysis related only to casting processes, but may be applied to various other processes.

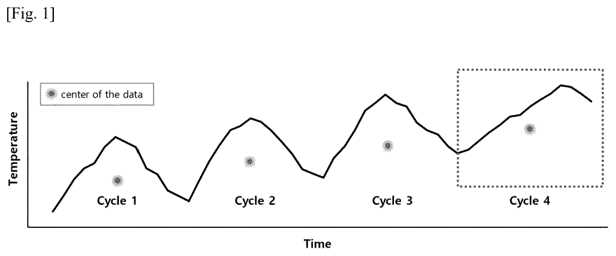

FIG. 1 is a temperature graph of a mold according to a casting process.

Referring to FIG. 1, the X-axis represents time, and the Y-axis represents measurement values of the mold used in the casting process. The graph shown in FIG. 1 distinguishes temperature values by cycle, and the points (circles) indicate the centers of the data. From the data represented by the center points, a trend of increasing temperature values as the process progresses can be observed. Additionally, it can be seen that the fourth cycle exhibits a pattern different from the other cycles. However, such pattern changes are difficult to detect using general characteristic values (e.g., maximum and minimum values of the data, average, median, variance, skewness, kurtosis, etc.). In cases such as the casting process presented as an example in this specification, where different types of data such as PLC control logic data and temperature sensor data are collected together, it is difficult to determine abnormalities using conventional techniques. In contrast, the process analysis apparatus and method according to the present specification can interpret cycle data as images and detect pattern changes occurring within the images.

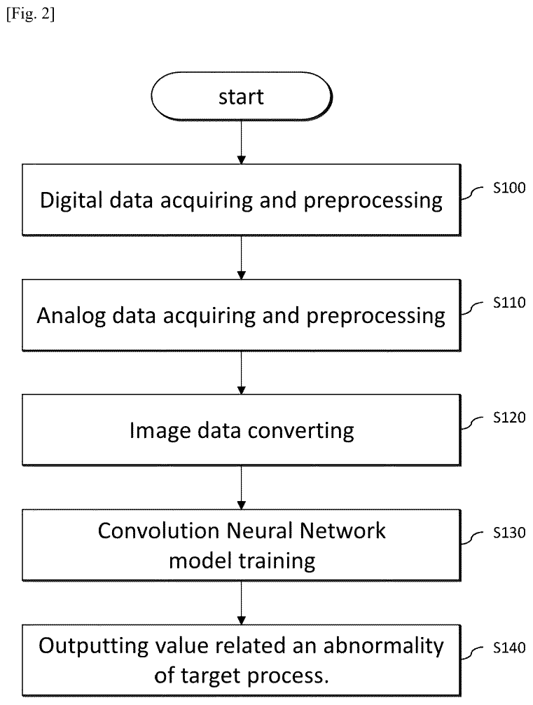

FIG. 2 is a schematic flowchart of a process analysis method according to the present specification.

First, in step S100, digital data acquired during a process may be segmented according to process cycles and converted into a Gantt chart format. The digital data is signal-type data having values of either 0 or 1.

According to one embodiment of the present specification, the digital data acquired during the process may be PLC control logic data.

A PLC (Programmable Logic Controller) is primarily used for building automation lines and is driven by specifications (PLC control logic code) written using relatively simple functions such as logical operators (e.g., AND/OR) and TIMER/FUNCTION BLOCKs. The control logic is defined using memory addresses of the PLC hardware, which are referred to as contacts. By defining input/output relationships for these contacts and controlling their values based on different situations, the automation line is operated.

In general, PLC control logic contains numerous contacts depending on the scale of the automation line. The contacts can be classified into “X contact data,” which are control input signals, and “Y contact data,” which are control output signals. X contacts are used solely as simple input signals for equipment operation and therefore do not directly correlate with the actual operation of the equipment. In contrast, Y contacts are output signals resulting from equipment operation and are related to whether the equipment is actually functioning. Preferably, the process analysis apparatus and method according to the present specification may acquire output data (Y contacts) from the PLC data, which are directly associated with actual equipment operation. For ease of interpretation, the digital data may need to be slightly processed.

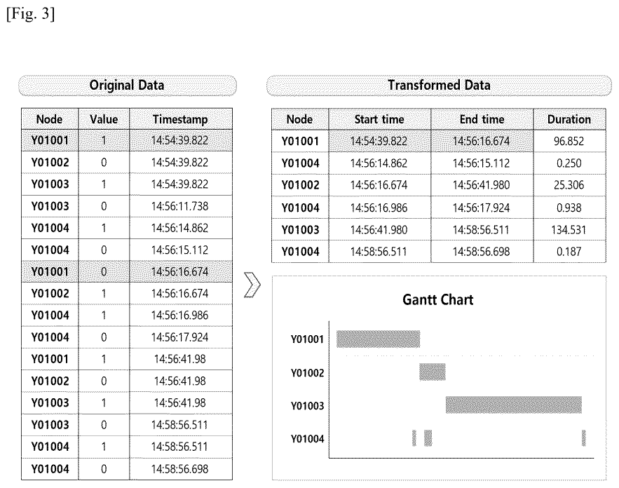

FIG. 3 is a reference diagram for preprocessing of digital data according to the present specification.

Referring to FIG. 3, the preprocessing procedure of digital data according to the present specification can be shown. Y contacts are digital signal-type data having values of 0 or 1. In the digital data, a contact value of 1 indicates the start of a new operation, while a value of 0 indicates the end of an existing operation. Accordingly, by extracting the section where the value changes from 1 to 0 at the same node, the start and end times of equipment operation can be mapped. By repeating the same procedure for each node, an operation table for each piece of equipment can be extracted, and using the node information, start time, and end time in the table, the equipment operation can be represented in the form of a Gantt chart.

The digital data requires segmentation. A repeatedly occurring identical process in manufacturing is referred to as a “cycle.” Each cycle contains pattern information on data changes within the process. In the present specification, the process of separating process data by cycle is referred to as “segmentation.” Segmentation is the process of extracting and separating unique data pattern information that appears in each cycle, and it serves as a fundamental task for process analysis.

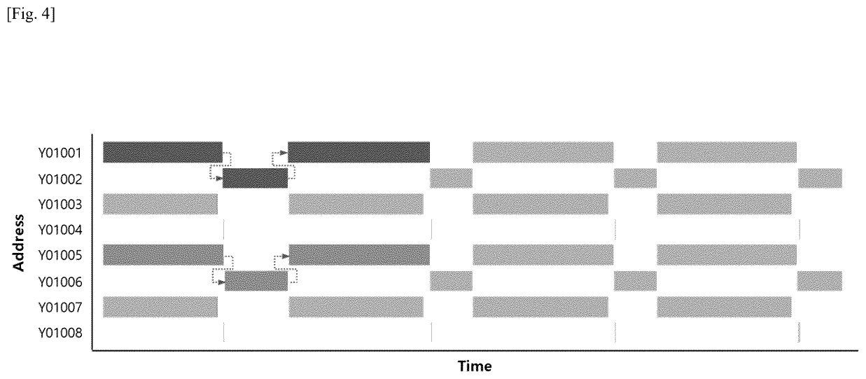

FIG. 4 is an exemplary diagram showing a portion of the Gantt chart of digital data and the connection relationship of operations.

Referring to FIG. 4, it can be seen that the operations of the Y01001 contact and the Y01002 contact have a sequential relationship. The operation of the Y01002 contact begins at the same time the operation of the Y01001 contact ends, and the reverse is also true. Such a relationship is not limited to the Y01001 and Y01002 contacts but can be similarly observed in other contacts as well. From the relationships between contacts, start and end information for each cycle can be extracted, which serves as the basis for defining the cycle. By utilizing these characteristics of the process, cycle information can be extracted.

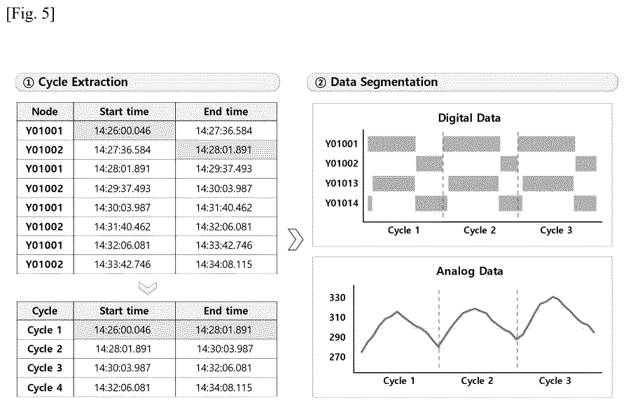

FIG. 5 is an example of segmentation of casting process data.

The casting process has a complex nature in which multiple operations occur simultaneously, resulting in the presence of multiple cycles at a single point in time. While it is possible to separate and analyze each cycle individually, the present specification provides, for ease of understanding, an example of segmentation into a single cycle based on the Y01001 and Y01002 contacts. By mapping the start time of Y01001 and the end time of Y01002 to the start and end times of a cycle, a cycle table can be extracted, and the cycle time information can be distinguished on a per-cycle basis.

For the convenience of explanation, the present specification describes converting digital data into a Gantt chart format and then performing segmentation. However, the process analysis apparatus and method according to the present specification may also perform segmentation of the digital data and then convert it into a Gantt chart format. In addition, for the segmentation of digital data, the master pattern generation method disclosed in Korean Patent Application Nos. 10-2021-0046618 and 10-2021-0050982, filed by the present applicant, may be applied, and the present specification incorporates by reference the entire contents of the specifications of the above patent applications.

Meanwhile, the Gantt chart has a format in which the X-axis represents time and the Y-axis represents Y contacts. Since the neural network model, which will be described later, learns equipment operation patterns from the Gantt chart image, the order of the Y contacts is important. If this order is changed, the patterns will vary, which may cause confusion during the training of the neural network model.

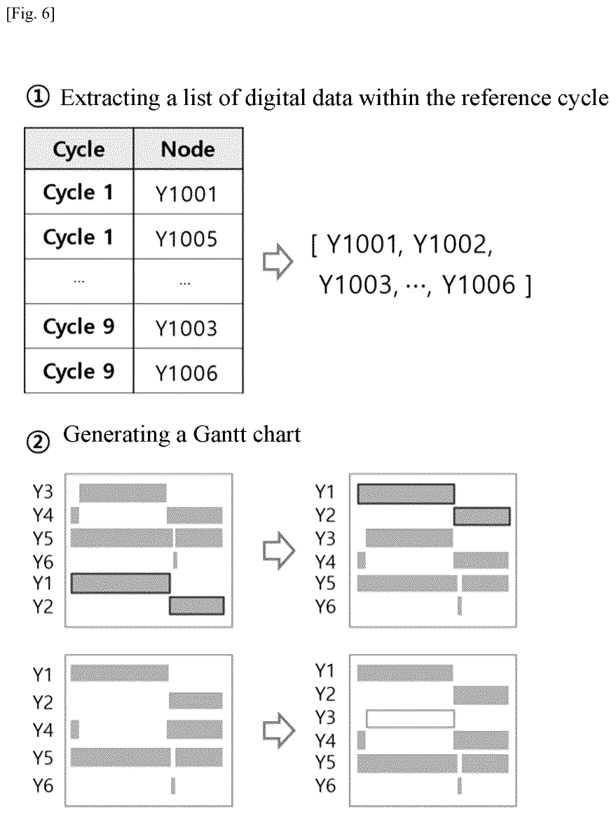

FIG. 6 is a reference diagram of digital data processing for effective training of a neural network model.

The process analysis apparatus and method according to the present specification may select one reference cycle from among a plurality of cycles, extract a list of digital data (contacts) within the reference cycle, and generate a Gantt chart corresponding to each cycle based on the order of the extracted digital data (contacts).

Furthermore, in digital data, there may be cases where some data within a cycle is not collected. This indicates the omission of specific equipment operations during the process, and therefore, it is necessary to process the data so that the neural network model can recognize this fact. That is, the process analysis apparatus and method according to the present specification may convert the digital data into a Gantt chart format in such a way that even digital data not collected during the process is indicated in terms of its presence. Referring to the lower part of FIG. 6, it can be seen that the “Y3 contact” is missing. Even if the Y3 contact is not collected, “Y3” is still included in the list in the Gantt chart, and the corresponding section may be left blank or displayed differently from other normal sections.

Referring again to FIG. 2, in step S110, analog data acquired during each cycle o the segmented digital data may be matched with the segmented data and converted into a graph format. In the present specification, analog data refers to signal-type data expressed as continuous values.

Analog data may include sensor data output from various sensors such as voltage sensors, current sensors, temperature sensors, and vibration sensors. Unlike PLC digital data, which indicates the operational status of equipment, sensor data contains information that can be used to diagnose the condition of process equipment.

For example, by monitoring temperature sensor data, a sudden increase in temperature can be detected and interpreted as an abnormal condition such as equipment overheating or a cooling system malfunction, thereby enabling diagnosis of faults in related equipment. In the casting process, the sensor data collected may relate to mold temperature, and two types of data may be collected: front mold temperature and rear mold temperature. In the present specification, mold temperature sensor data is used as an example of analog data.

The collected analog data may be segmented in accordance with the cycle units of the digital data. In other words, the analog data may be extracted based on the start and end times of each cycle and matched with the segmented digital data. Each segmented analog data set may then be converted into a graph format (see FIG. 5).

For the convenience of explanation, the present specification describes segmenting analog data and then converting it into a graph format. However, the process analysis apparatus and method according to the present specification may also convert the analog data into a graph format first and then perform segmentation.

Meanwhile, analog data is in the form of a two-dimensional graph, with time on the X-axis and output values (e.g., voltage, current, temperature, etc.) on the Y-axis, and its shape can vary. Since the process analysis apparatus and method according to the present specification focus on whether equipment is operating normally, changes within the cycle data are considered important. More specifically, even if the starting position or the peak position of the graph differs, it is considered the same pattern if the rising and falling trends are similar. Therefore, a normalization process is necessary to standardize the graph format so that the neural network model can focus on the relative variation in the data.

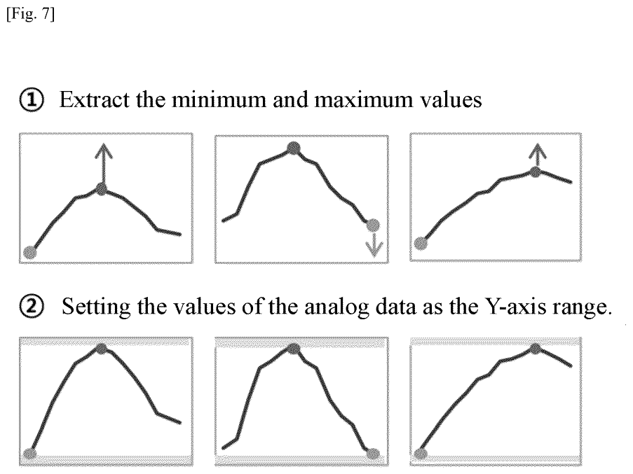

FIG. 7 is a reference diagram of analog data processing for smooth training of a neural network model.

Referring to FIG. 7, the process analysis apparatus and method according to the present specification may convert the analog data for each cycle into a graph format by setting the minimum and maximum values of the analog data as the Y-axis range.

Referring again to FIG. 2, in the next step S120, the Gantt chart and the graph corresponding to each cycle may be converted into a single image data.

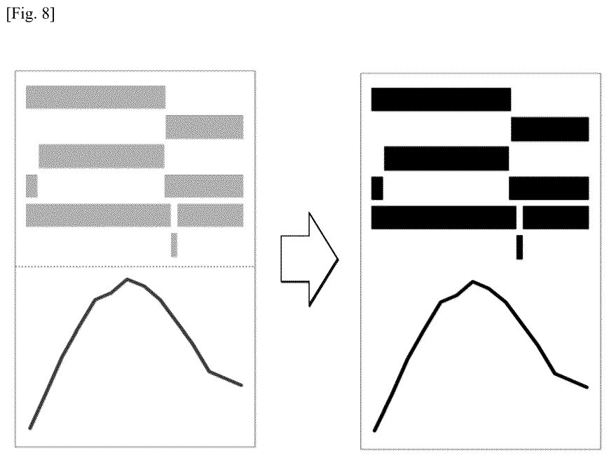

FIG. 8 is an example of image data in which digital data and analog data are combined.

Referring to FIG. 8, an example is shown in which the Gantt chart corresponding to the digital data and the graph corresponding to the analog data are vertically combined. Through the image data, the neural network model described later can consider both digital and analog data simultaneously. Preferably, in the image, the Gantt chart and the graph have the same horizontal length. Also preferably, the image of the Gantt chart and the graph may be converted into a black-and-white image. Since process operation analysis involves analyzing whether equipment is operating or not, there is no need to use RGB values.

Referring again to FIG. 2, in step S130, a model composed of a Convolutional Neural Network (CNN) may be trained using the image data.

The CNN Autoencoder learns a process in which it compresses (encodes) an image and then reconstructs (decodes) it to match the original image. Since this neural network model learns through self-supervised learning, it can be utilized even in environments without labeled data. The CNN Autoencoder model is also used for anomaly detection. When used for anomaly detection, the model is trained using only normal data so that it learns how to reconstruct normal data. When an abnormal image is input into a model trained only on normal images, the decoding process does not perform properly, resulting in a large reconstruction error—this property is used to detect anomalies.

The trained CNN Autoencoder model performs encoding and decoding on all input image data and calculates the reconstruction error by comparing the reconstruction result with the original input data. This reconstruction error is an indicator of how accurately the model can reconstruct the input data. A model trained to reconstruct normal images will have difficulty reconstructing abnormal images in the same form as the input, resulting in a relatively larger reconstruction error.

The process analysis apparatus and method according to the present specification may convert image data into matrix values and input them into the convolutional neural network model.

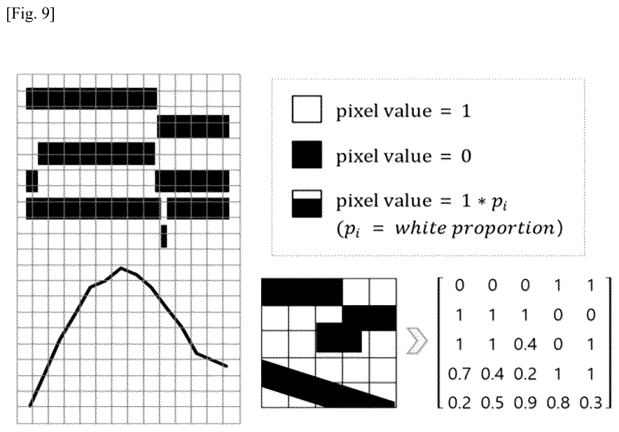

FIG. 9 is an exemplary diagram showing the conversion of image data into matrix values.

Referring to FIG. 9, according to one embodiment of the present specification, in step S130, a feature matrix may be extracted by assigning a value of “1” to each grid of the image data where the color is white and a value of “0” where the color is black, and the extracted feature matrix may be input into the convolutional neural network. If a grid does not clearly distinguish the boundary of the Gantt chart and the graph and contains a mixture of colors, the matrix value may be extracted based on the ratio of colors within the grid.

The number and size of the grids may be determined based on the matrix size (M×N) when converting the image data into a matrix. For example, if the entire image is divided into 180×120 sections, the total number of grids would be 21,600. If the image is divided into 360×240 sections, the total number of grids would be 86,400.

Referring again to FIG. 2, in the final step S140, an image data generated through the same procedures as in steps S100 to S120 for the target process to be analyzed may be input into the trained convolutional neural network model, and output a value from the convolutional neural network model related an abnormality in the process. The output value from the convolutional neural network model may be used to determine whether there is an abnormality in the process. The abnormality of the process may be determined based on whether the reconstruction error exceeds a predefined threshold. If the reconstruction error exceeds the set threshold, the corresponding input data may be classified as abnormal. The reconstruction error threshold may vary depending on the characteristics and requirements of the field.

While the embodiments of the present specification have been described above with reference to the accompanying drawings, those skilled in the art to which the present specification pertains will understand that the present invention can be embodied in other specific forms without changing its technical spirit or essential features. Therefore, it should be understood that the above-described embodiments are merely illustrative in all respects and not restrictive.

What is claimed is:

1. A process analysis apparatus, comprising:
a hardware processor; and
a memory connected to the processor and storing at least one computer program configured to perform a process analysis method,
wherein the process analysis method comprises:
(a) segmenting digital data acquired during a process according to process cycles and converting the segmented digital data into a Gantt chart format;
(b) matching analog data acquired during each cycle of the segmented digital data with the segmented digital data and converting the matched analog data into a graph format;
(c) converting the Gantt chart and the graph corresponding to each cycle into a single image data;
(d) training a model composed of a convolutional neural network using the image data; and
(e) inputting an image data, generated through the same procedures as in steps (a) to (c) for a target process to be analyzed, into the trained convolutional neural network model, and outputting a value from the convolutional neural network model related an abnormality in the process.

2. The process analysis apparatus according to claim 1,
wherein the digital data acquired during the process is PLC control logic data.

3. The process analysis apparatus according to claim 1,
wherein the step (a) comprises selecting one reference cycle from among a plurality of cycles, extracting a list of digital data within the reference cycle, and generating a Gantt chart corresponding to each cycle based on the order of the extracted digital data.

4. The process analysis apparatus according to claim 3,
wherein the step (a) further comprises converting the digital data into a Gantt chart format in such a way that even digital data not collected during the process is indicated in terms of its presence.

5. The process analysis apparatus according to claim 1,
wherein the step (b) comprises converting the analog data for each cycle into a graph format by setting the minimum and maximum values of the analog data as the Y-axis range.

6. The process analysis apparatus according to claim 1,
wherein the step (c) comprises converting the Gantt chart and the graph into black-and-white images having the same horizontal length.

7. The process analysis apparatus according to claim 6,
wherein the step (d) comprises extracting a feature matrix such that a value of “1” is assigned to each grid of the image data where the color is white and a value of “0” where the color is black, and inputting the extracted feature matrix into the convolutional neural network.

8. The process analysis apparatus according to claim 7,
wherein the step (d) further comprises, in a case where a grid does not clearly distinguish the boundary of the Gantt chart and the graph and contains a mixture of colors, extracting a matrix value based on the ratio of colors within the grid.
